(19) United States
(12) Patent Application Publication
(10) Pub. No.: US 2024/0399602 A1
(43) Pub. Date: Dec. 5, 2024

(54) FOOD PROCESSING LINE AND METHOD FOR OPERATING A FOOD PROCESSING LINE

(71) Applicant: Weber Food Technology GmbH, Breidenbach (DE)

(72) Inventors: Rene Kamsteeg, Lochem (NL); Ingo Rother, Breidenbach (DE); Karl-Heinz Mayer, Frankfurt am Main (DE)

(21) Appl. No.: 18/699,014

(22) PCT Filed: Oct. 6, 2022
(86) PCT No.: PCT/EP2022/077788

§ 371 Date: May 6, 2024

(30) Foreign Application Priority Data
Oct. 11, 2021 (DE) 10 2021 126 323.9
Jan. 11, 2022 (DE) 10 2022 100 537.2

(51) Int. Cl. B26D 5/00; B26D 7/32; B65B 57/10

(52) U.S. Cl. CPC B26D 5/007; B26D 7/32; B65B 57/10; B26D 2210/02

(57) ABSTRACT

The invention relates to a food processing line, in particular having at least one slicing machine, a sorting and conveying path and/or a packaging machine, said food processing line comprising a sensor apparatus for determining irregularities in the operating procedure and a point in time of the determined irregularity, at least one camera in order, during operation, to continuously record images of at least one region of the food processing line in which a cause of an irregularity can be present, and a central data processing device that, during operation, receives data from the sensor apparatus and from the at least one camera and that is configured and set up to select the images that are relevant for determining a cause of the irregularities from the images recorded by the camera. The invention furthermore relates to a corresponding method of operating a food processing line.

### RELATED APPLICATION

The present application is a national stage application under 35 U.S.C. § 371 of International Application No. PCT/EP2022/077788, filed 6 Oct. 2022, which claims priority from German Patent Application No. 10 2021 126 323.9, filed 11 Oct. 2021 and German Patent Application No. 10 2022 100 537.2, filed 11 Jan. 2022. The above-referenced applications are incorporated by reference.

### SUMMARY

The invention relates to a food processing line and to a method of operating such a food processing line.

Specifically, the invention relates to a food slicing and/or food packaging line, in particular for processing sausage, cheese, ham and other similar food products, and to a method of operating such a food slicing and/or food packaging line. Food products such as sausage, cheese, ham and other similar food products are usually handled as a natural product in a first processing process or formed from at least one natural product, for example into product bars. Depending on the desired end product, storage, maturing, pre-treatment, drying, humidifying and/or temperature control processes follow.

Once the desired end product has been produced, the food product is usually divided into portions suitable for sale in a food processing line. Food products to be sliced, i.e. food products that are sold to the end customer cut into individual slices, are fed to a slicing machine, in particular a high-performance slicer, and cut into slices by the slicing machine. Before the food products are fed to the slicing machine, the food products can pass through even further stations such as a cheese divider, a peeling machine and/or a pre-cooling device.

The food product is usually cut into slices by the slicing machine such that portions consisting of several slices are produced. These portions usually pass through a sorting and conveying path downstream of the slicing machine. The sorting and conveying path can comprise a weighing station in which the individual portions are weighed. The sorting and conveying path can also comprise a station to displace the portions transversely, i.e. in a direction transverse to the main conveying direction. The sorting and conveying path can furthermore comprise a station to overlap portions or individual slices and/or to form format sets. A station can be provided at the end of the sorting and conveying path to transfer the portions to a packaging machine. The portions can, for example, be inserted into packages by means of a robot or a feeding belt. After the portions have been placed in the appropriate packages, for example thermoformed trays, the packages are usually sealed at a sealing station. The packages, which are usually contiguous, can then be separated from one another by means of a longitudinal cutting device and a transverse cutting device. The packages that are loaded with portions, sealed and separated from one another can then also be subjected to a final inspection, for example by weighing the packages by means of a final checkweigher. The packages are then usually packed in cardboard boxes.

In such a food processing line, a plurality of irregularities can occur in the operating procedure and can lead to disruptions in the food processing line. If the food processing line has to be shut down due to a disruption, the economic benefit of the food processing line is reduced. It is therefore advantageous if, in the event of an irregularity, it can be determined as quickly and reliably as possible and adjustments can be made. At best, disruptions can be prevented and it can be ensured that the food processing line only has to be shut down for as short as possible a period, if at all.

It is an object of the present invention to provide a food processing line by means of which irregularities, in particular their origin, can be detected as quickly and reliably as possible.

The object is satisfied by a food processing line as described herein and in particular in that the food processing line comprises a sensor apparatus for determining irregularities in the operating procedure and a point in time of the determined irregularity, at least one camera in order, during operation, to continuously record images of at least one region of the food processing line in which a cause of an irregularity can be present, and a central data processing device that, during operation, receives data directly from the sensor apparatus, from the at least one camera and possibly also from the line control and that is configured and set up to select images that are relevant for determining a cause of the irregularities from the images recorded by the camera.

Selecting the images recorded by the camera can, for example, comprise marking a relevant section of a longer video. For example, the marked section can then be displayed to a user so that the user can manually play the marked section of the video. The selection of the images recorded by the camera can also comprise a playback, in particular an automatic playback, of a relevant section of a longer video. Alternatively or additionally, selecting the images recorded by the camera can also comprise extracting and/or automatically processing a relevant section of a longer video or the relevant images. Many different variants of processing the relevant images are conceivable. Some of these variants are described below.

Irregularities in the operating procedure can, for example, be present when a value measured by a sensor of the food processing line, such as a temperature of the food product, a feed speed of a gripper, etc., is outside a desired range. Such a desired range defines a range for the respective measured value in which the food processing line can be operated without having to expect a loss in production quality. The desired ranges for the respective values can be set and/or adjusted by operators of the food processing line, but should ideally already be set or be set or readjusted by the food processing line itself.

However, an irregularity in the operating procedure can also be present when a plurality of values do not lie in a desired range when viewed together. For example, values that are in a ratio to one another can be compared and an irregularity can then be determined if their ratio is outside a desired range. An example of two values in a ratio to one another is the feed speed of the gripper and the cutting speed of the slicing machine. Specifically, the irregularity in the operating procedure can be determined by recognizing patterns in the measured values. In this respect, a large amount of sensor data can be determined and changes in the measured values that are characteristic of disruptions can be recognized by means of artificial intelligence. For example, individual or a large number of measured sensor values can be compared with line settings, i.e. line parameters, and anomalies can be detected, preferably by means of artificial intelligence. For example, a speed of the portions on a conveyor belt could be measured by a camera and this speed could be compared with the set speed of the conveyor belt. If there is a deviation between these speeds, this can, for example, be an indication that the drive motor of the conveyor belt is damaged.

Advantageous embodiments of the invention can be seen from the dependent claims, from the description, and from the drawing.

According to one embodiment, the data processing device is configured and set up to automatically recognize a cause and/or the point of origin of the irregularity based on the relevant images. Alternatively or additionally, the data processing device can be configured and set up to automatically recognize a cause and/or the point of origin of the irregularity based on relevant sensor data acquired by the sensor apparatus. The data processing device is preferably also configured and set up to propose or initiate suitable countermeasures. The data processing device is preferably configured and set up to automatically determine relevant information from several different images or different videos that is relevant for recognizing a cause of the irregularity. In addition to the images, the data processing device can furthermore be configured and set up to also evaluate sensor data of the food processing line, such as weight data of a scale, in order to determine the cause of the irregularity.

Furthermore, the data processing device can be configured and set up to determine and, if necessary, sort out incorrect portions at the point of origin or at least at a corresponding station. For example, when forming portions, an incorrect movement of the portioning belt can cause a portion to be obliquely oriented. Alternatively or additionally, the processing temperature of the product to be sliced could be the cause of a slanted or improperly formed portion. Such an obliquely oriented portion then should not be transported further up to a pick-and-place robot before the irregularity is detected, but the irregularity should be detected immediately, where possible, in order to eliminate it promptly. The faulty portion can then, for example, be sorted out directly at the portioning belt via a rocker.

Alternatively thereto, the selected images can be provided and/or played to a person who is responsible for analyzing system faults. Thus, although the processing line can automatically select the images that are relevant for determining a cause of the irregularities from the images recorded by the camera, an assessment of the images and an associated decision on the cause of the irregularity is in this case the responsibility of the user, i.e. a natural person. In this respect, a combination is also conceivable in which the user determines the cause of the irregularity and the data processing apparatus suggests countermeasures based thereon.

According to one embodiment, the data processing device is configured and set up to learn through machine learning what the cause of the determined irregularities is. Alternatively or additionally, the data processing device can be configured and set up to learn through machine learning how certain determined irregularities are to be eliminated. The data processing device can be configured and set up to learn through machine learning how certain irregularities can be recognized based on the images recorded by the camera. The data processing device can furthermore be configured and set up to learn through machine learning which images or video sequences must be selected from the images recorded by the camera in order to recognize irregularities based on the images recorded by the camera. The data processing device can be taught by a machine in that the data processing device receives data sets, so-called training data. These data sets can contain videos of known irregularities and information on what these irregularities are and how they can be eliminated. The data sets can comprise sequences at the food processing line that show a proper procedure of the stations. Alternatively or additionally, the data sets can contain videos with process steps that are not taking place properly. According to one embodiment, the data sets are grouped into processes that took place properly and processes that took place improperly. The grouping can take place either by manual input or based on additionally recorded data, for example a video of a person taking a bad portion from a conveyor belt. Alternatively thereto, the data processing device itself searches for distinguishing features between process sequences without irregularity and process sequences with irregularity in order to group them.

Furthermore, the data processing device can be configured and set up to automatically classify determined irregularities as unproblematic, preferably based on the images generated by the camera. To reduce such false-positively determined irregularities, the data processing device can be configured and set up to adjust the above-mentioned desired ranges.

According to one embodiment, a plurality of cameras are provided that, during operation, continuously record images of different regions of the food processing line in which a cause of an irregularity can be present, wherein the recording regions can also at least partly overlap. All relevant regions of the food processing line are preferably monitored by a camera so that many causes of an irregularity can be detected. Everything that is explained in this description with regard to one camera preferably accordingly also applies to all other cameras. The plurality of cameras can comprise mobile cameras and stationary cameras. A mobile camera according to this application is a camera that is temporarily attached to the food processing line at a position of the food processing line or arranged in the region around the food processing line and is then attached or arranged at another position or another food processing line. Such cameras are usually very expensive and are therefore only used temporarily, for example to find a solution to a specific problem, and are subsequently deployed elsewhere. In contrast, a camera that is attached or arranged at a position of the food processing line and remains at this position over an operating period of the food processing line is regarded as a stationary camera. According to one embodiment, all the cameras of the food processing line are connected to the data processing device of the food processing line in a closed system. This means that the data acquired by the cameras cannot be accessed by third parties or stored on third-party servers. This ensures that the acquired data cannot be viewed by third parties.

According to one embodiment, the sensor apparatus comprises a plurality of sensors, which in particular differ in terms of their type, to determine various irregularities in the operating procedure. This can also include operationally necessary sensors in line components. For example, the sensors can comprise speed sensors that measure the cutting speed of the slicing machine, conveying speeds of various endless conveyor belts of a sorting and conveying path or feed speeds of grippers of the slicing machine. The sensors can furthermore comprise position sensors that determine, for example, a current position of the cutting head of the slicing machine or a current position of a pick-and-place robot. The sensors can also comprise temperature sensors, for example to measure temperatures at drives, in the environment or of the food product. The sensors can also comprise light barriers, for example to determine an intervention by a user. The sensors can also comprise lasers, cameras or combinations thereof, for example to detect the dimensions or orientation of products or portions.

The sensor apparatus preferably comprises one or more of the cameras described above. In this case, the sensor apparatus can use the images recorded by the camera during operation to determine irregularities in the operating procedure and, furthermore, the central data processing device can use the data received from the camera to select images that are relevant for determining the cause of the irregularities from the images recorded by the camera. For example, a camera directed at a conveyor belt can determine that a portion lying on the conveyor belt has slipped sideways so that this is to be regarded as an irregularity. The central data processing device can also select, from the camera images, the images that show that a person has come up against the portion that has slipped sideways. To eliminate the irregularity, the data processing device can automatically inform a pick-and-place robot that this portion must be picked up from another position of the conveyor belt or should not be picked up at all.

According to one embodiment, the data processing device is configured to automatically perform a prioritization when a plurality of irregularities occur. For example, an algorithm is provided to calculate which of the determined irregularities must be eliminated first in order to keep a downtime of the food processing line as short as possible or, at best, to avoid it. For example, a prioritization can also be performed as to which irregularities can be automatically eliminated by the data processing device and which irregularities must be eliminated by a user, for example by replacing a part.

According to one embodiment, the data processing device is configured to detect trends, in particular wear at the food processing line, based on the determined irregularity. For example, the data processing device can be configured to recognize that a value, for example measured by a sensor of the sensor apparatus, changes over time and that it is therefore likely that the value will exceed a threshold value in the future that could then lead to a disruption. In this case, the data processing device can initiate countermeasures in good time before the threshold value is reached or can inform the user that, for example, a wear part will soon need to be replaced. The data processing device can, for example, use artificial intelligence to determine when wear parts should be replaced in order to minimize the downtime of the food processing line or its modules.

According to one embodiment, the data processing device is configured to determine incorrect settings at the food processing line based on the determined irregularity. The data processing device is preferably configured and set up to automatically correct the incorrect settings. Alternatively or additionally, the data processing device can be configured to inform a user when an incorrect setting has been determined. An incorrect setting can, for example, be an incorrectly set operating parameter, e.g. an incorrectly set feed speed of the product to be sliced. An incorrect setting can furthermore be an incorrect setting of a part of the food processing line, e.g. a cutting gap at the slicing machine that is set too large or too small.

According to one embodiment, at least one camera is configured as a spectral camera. A spectral camera serves to capture images in the visible and non-visible spectral range and to process them such that aspects not originally visible to the human eye become visible. Such spectral cameras can, for example, be used in the food processing line to perform a sealing seam inspection in the packaging machine or to recognize foreign bodies, a mold infestation or other contamination or relevant conditions of the food product.

The invention furthermore relates to a method of operating a food processing line. The food processing line may have one or more of the features described above or below.

The method of operating a food processing line has the following steps:
detecting at least one section of the food processing line by means of a camera,
detecting an irregularity in the operating procedure by means of at least one sensor, for example by means of a sensor of the food processing line or a camera,
determining a point in time of the detection of the irregularity,
automatically selecting the data acquired by the camera in the period in which the irregularity arose, and
determining the cause of the irregularity by means of the selected data.

Using this method, irregularities in the operating procedure of a food processing line can be detected as quickly and reliably as possible.

According to one embodiment, the method further comprises eliminating the cause of the irregularity by means of measures necessary for this purpose. The elimination of the cause can, usually depending on the type of cause, be performed by a person and/or in an automated manner.

According to one embodiment, the method furthermore comprises assigning operating data and/or operating parameters to the camera data. For example, operating data acquired by sensors can be assigned to the camera data acquired at this point in time. This preferably takes place fully automatically.

According to one embodiment, the determination of the cause of the irregularity is automatically performed by a data processing device by means of the selected data.

Alternatively thereto, the images recorded by the camera, e.g. a video, can be played to a skilled person so that he can determine the cause of the irregularity.

So that the cause of the irregularity can be determined as precisely as possible, the determination of the cause of the irregularity can comprise evaluating measured data of a plurality of sensors along the food processing line.

The elimination of the cause of the irregularity is preferably automatically performed by a data processing device by means of measures necessary for this purpose. For example, the data processing device can automatically adjust an operating parameter, e.g. the feed speed or cutting speed of the slicing machine. Alternatively or additionally, the data processing device can control a servomotor, for example to adjust the cutting gap at the slicer.

According to one embodiment, the elimination of the cause of the irregularity is performed considering data sets created in the past that relate to irregularities detected in the past. The data sets can comprise the following data, among others: Temperature data of the product, temperature data of the environment, speed data of moving parts of the apparatus. It can generally be assumed that the same or similar data sets lead to the same or similar irregularities and thus the irregularities can also have similar causes and these causes should therefore be checked. Furthermore, if a plurality of irregularities have been determined, the sequence of the irregularities can be compared with data sets created in the past relating to sequences of irregularities. If the same or similar sequences of irregularities are already known, it can first be checked whether the cause assigned to the sequences is also present again this time.

According to one embodiment, the elimination of the cause of the irregularity comprises changing, in particular automatically changing, a setting of the food processing line. The setting can, for example, be a speed setting of a conveyor belt or a cutting speed of the slicing machine. It can also be a setting that is made by adjusting a part of the food processing line by means of a servomotor, for example a setting of the width of cutting spectacles/cutting frame or of the cutting gap. Some irregularities can be eliminated in several ways/by several methods. These methods can be categorized into methods that lead to a standstill of the food processing line and methods that can be performed without a standstill of the food processing line. According to one embodiment, the elimination of the cause of the irregularity comprises analyzing whether a temporary solution, i.e. a solution without stopping the food processing line, is possible and sensible, and thus whether a stopping of the food processing line can be postponed. For example, it may happen that the food product is no longer sliced with sufficient quality due to a blunt cutting blade. One solution would be to replace the cutting blade with a sharper cutting blade. Another temporary solution would be to reduce the feed speed at the slicer to improve the cutting quality at the expense of the cutting speed. This could postpone the replacement of the cutting blade, and thus a stopping of the food processing line, until any other wear parts need to be replaced or the food processing line needs to be reloaded.

The method can furthermore comprise:
saving the measures required for eliminating the cause,
detecting similar or identical irregularities in the operating procedure by means of at least one sensor,
eliminating the cause of the irregularities in an automated manner by means of the saved measures.

Alternatively thereto, instead of an automatic or automated elimination of the cause, a semi-automatic elimination of the cause can be performed during which an operator or a service employee is given a suggestion for eliminating the cause of the irregularity and must manually approve the suggestion.

According to one embodiment, the determination of the cause of the irregularity comprises comparing data collected on the irregularity with data from previously detected irregularities. For example, a plurality of process parameters can be compared with one another and similarities between the process parameters determined for the newly determined irregularity and process parameters for previously detected irregularities can be determined. Previously detected irregularities can also refer to irregularities from other lines, specifically also at other locations or in digital twins.

According to one embodiment, the determination of the cause of the irregularity is performed by using artificial intelligence. Specifically, the determination of the cause of the irregularity can be performed by analyzing videos and/or other types of sensor data by means of artificial intelligence. The determination of irregularities can hereby take place in a fully automated manner and, consequently, time and personnel costs can be saved and the personnel can be relieved.

The method can furthermore comprise categorizing the detected irregularity by type of irregularity, the component concerned, the point in time of the detection of the irregularity, the point in time of the occurrence of the irregularity, the station of the occurrence of the irregularity and/or the severity of the irregularity. Using these data, a prioritization of the irregularity can, for example, be performed and, depending on the prioritization, it can be decided whether the food processing line or parts thereof have to be stopped. For example, the categorized irregularities can be used to generate statistics. The statistics can be used, for example, to show the manufacturer of the food processing line weak points in the design or setting in order to optimize these weak points in food processing lines manufactured in the future. To make the statistics more meaningful, the detected irregularities from a plurality of food processing lines, even from different customers, can be categorized and statistics can be generated.

Furthermore, the method can comprise differentiating whether the irregularity is an isolated case or a recurring irregularity. If the irregularity is a recurring irregularity, data on the irregularity can be sent to the manufacturer of the food processing line for analysis in order to gain knowledge for the design or setting of future machines.

According to one embodiment, the data acquired by the camera are processed before the data are released for output or are output. To observe applicable data protection regulations, data that show persons can be anonymized. For example, the face or the entire body of the person can be pixelated. The central data processing device can be configured to process the data accordingly. If the data were acquired by a spectral camera, the data can be processed such that interference-relevant information, such as contamination of the food, becomes visible to the human eye.

### BRIEF DESCRIPTION OF THE DRAWINGS

The invention will be described in the following with reference to a purely exemplary embodiment and to the enclosed drawings. There are shown:

FIG. 1 is a first part of a food processing line according to the invention with a scanner and a high-performance slicer;

FIG. 2 is a second part of the food processing line according to the invention with a packaging machine;

FIG. 3 is a schematic representation of a line control according to the invention; and

FIG. 4 is a schematic representation of a method according to the invention of operating the food processing line.

### DETAILED DESCRIPTION

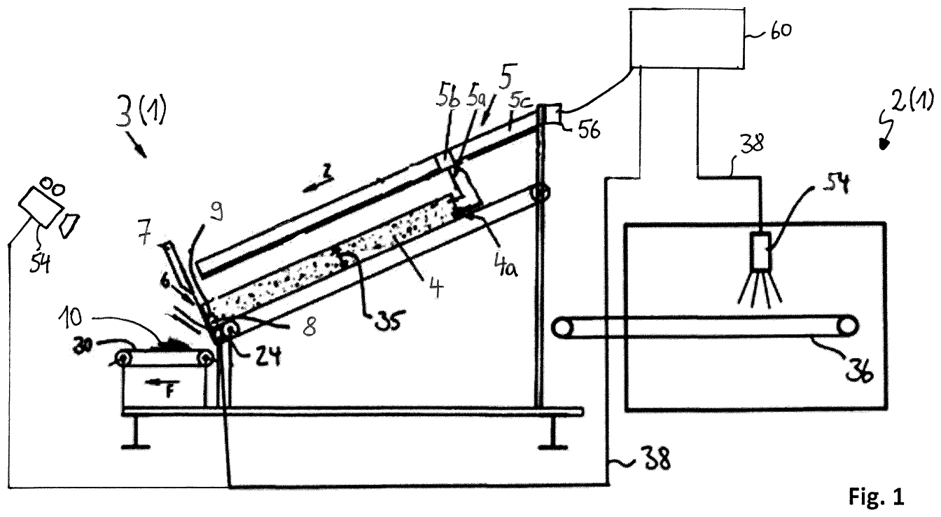

A first part of a food processing line 1 is shown in FIG. 1. This first part of the food processing line 1 comprises a scanner 2 and a slicing machine 3 for slicing food products 4 in the form of a high-performance slicer. The slicing machine 3 has a product feed 5 for the single-track or multi-track feeding of the food products 4 to be sliced in a feed direction Z to a cutting plane 6. The product feed 5 comprises a product holder 5a for holding a rear end region 4a of the food product 4, viewed in the feed direction Z. The product holder 5a is coupled to a spindle nut 5b that, together with a spindle 5c, forms a linear drive for the product holder 5a to drive the product holder 5a along the feed direction Z, and thus to feed the food product 4 to be sliced to the cutting plane 6. Furthermore, the product holder 5a is linearly displaceably supported at a guide rail, not shown, in the feed direction Z to support the product holder 5a in a statically determined manner. The product feed 5 comprises a sensor 56 by means of which at least one operating parameter of the product feed 5, for example a feed speed or a feed torque, is measured. The slicing machine 3 can comprise a plurality of further sensors, for example a light barrier. The sensors 56 are connected to a data processing device 60 so that process data measured by the sensors 56, in particular if the data deviate from a standard range, can be transmitted to the data processing device 60.

To cut the food product 4 into slices, the slicing machine 3 comprises a cutting blade 7 that rotates during operation, for example a circular blade or scythe-like blade, that performs a corresponding cutting movement during operation and moves along the cutting plane 6 in the process. The apparatus furthermore comprises a product passage 8 that forms a counter-blade 9 for the cutting blade 7. For this purpose, the product passage 8 is arranged in a front end region of a feed path. Furthermore, the slicing machine 1 comprises a portioning region with a portioning belt 30 on which cut-off slices of the food product 4 are placed as portions 10. A camera 54, here a high-speed camera, is provided for, in particular automatically, monitoring the cutting process. The camera 54 films the sequence of the cutting process and transmits the generated images to a data processing device 60.

The scanner 2 is connected upstream of the slicing machine 3, viewed in the conveying direction F. Parameters of the food product 4, for example geometric parameters of the food product 4 and/or its temperature, can be measured by the scanner 2. For this purpose, the scanner can be configured as a laser scanner or X-ray scanner and/or comprise a thermal imaging camera 54. The scanner 2 comprises a conveyor belt 36, here an endless conveyor belt, on which the food product 4 is positioned while the food product 4 is being measured. The scanner 2 is connected by data transmission means 38 to the data processing device 60 to transmit the determined data to the data processing device 60. As shown in FIG. 1, the data transmission means 38 can comprise a cable 38 extending from the scanner 2 up to the data processing device 60. Alternatively thereto, the data transmission means can be configured as wireless data transmission means and have a transmitter and a receiver.

For example, a block of cheese could lie obliquely in the scanner 2. In such a case, the data processing device 60 would recognize, based on the camera images from the scanner, that the block of cheese is not oriented in a sufficiently straight manner. The realization that the block of cheese is not oriented in a sufficiently straight manner can be reached by a comparison with images of blocks of cheese that are oriented in a straight/oblique manner. To eliminate the irregularity, lateral sliders can be provided to orient the block of cheese in a straight manner in the scanner 2.

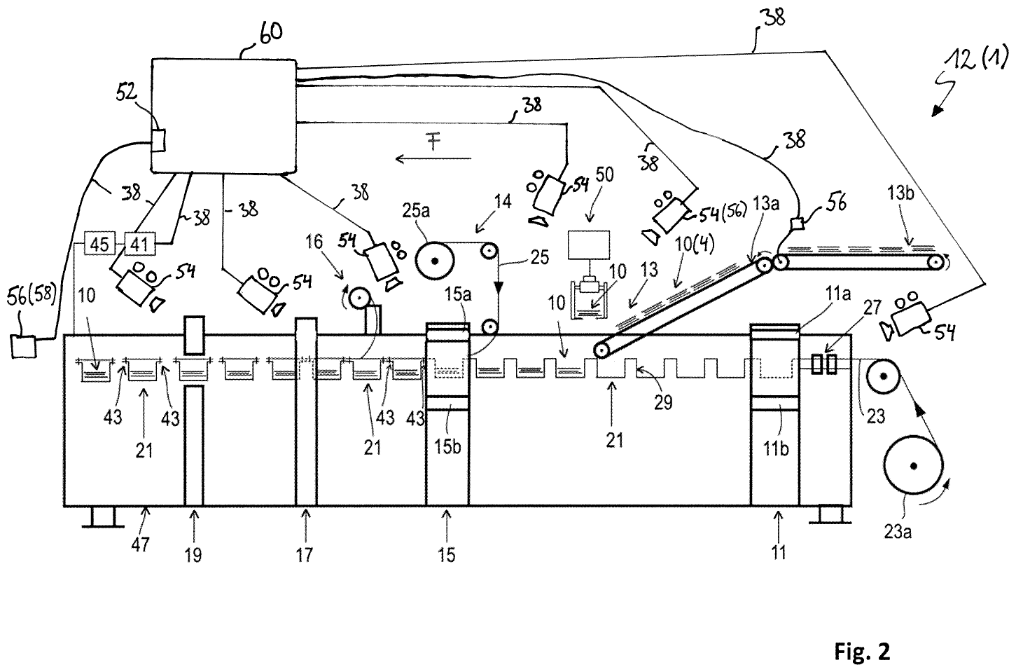

FIG. 2 shows a packaging machine 12 operating in a conveying direction F. The packaging machine 12 comprises a machine frame 47. A transport chain 27, which is only schematically shown here at the upstream end of the machine, is guided at a left side frame and at a right side frame of the machine frame 47 in each case. The two transport chains 27 together form a conveying means for a bottom film 23 drawn off from a supply roll 23a.

The packaging machine 12 comprises a plurality of consecutive work stations in the direction of transport T, namely a molding station 11 also designated as a deep-drawing machine or a thermoforming machine, an insertion station 13 for products 4 to be packaged, a feed station 14 for a top film 25 drawn off from a supply roll 25a, a sealing station 15 for connecting the bottom film 23 to the top film 25, a labeling station 16, a transverse separation station 17, and a longitudinal separation station 19, i.e. an apparatus 19 for cutting packages 21 to size along a longitudinal direction.

The products 4 to be packaged are food products in the form of so-called portions 10 that each comprise a plurality of slices that were previously cut off from a loaf-shaped or bar-shaped food product 4, such as sausage, cheese, ham or meat, by means of the slicing machine 3 (see FIG. 1).

A control device 41, which is associated with the packaging machine 12 and connected to the data processing device 60, controls the operation of the packaging machine 12, including the workstations mentioned. Furthermore, the packaging machine 12 is provided with an operating device 45 that e.g. comprises a touch screen at which all the necessary information can be displayed to an operator and the operator can make all the necessary settings before and during the operation of the machine. Preferably, when the operator changes a setting, a preliminary calculation can be made by the control device 41 or the data processing device 60, and a visualization of the consequences of the change can be displayed. If a problem is recognized with the change, a warning can be issued and/or a video recorded by a camera can be played that shows the problem. To make it easier for the user to make settings, e.g. to change operating parameters, desired ranges can be displayed in which the settings should be located. Settings for the entire food processing line 1 can preferably be changed via the one operating device 45.

At the molding station 11, which comprises a top tool 11a and a bottom tool 11b, recesses 29, also designated as depressions, are formed in the bottom film 23 in a deep-drawing process in each case. The products or portions 10 mentioned are inserted into these recesses 29 at the insertion station 13. The insertion station 13 here comprises a so-called feeder of which two endless conveyor belts 13a, 13b are shown. Alternatively or additionally, the insertion station 13 can comprise a robot 50, e.g. in the form of a so-called “picker” or “pick-and-place robot”, that is likewise schematically shown here and that can be configured as a delta robot having a gripper 52 that comprises two claws jointly holding a respective portion 10. Such robots and their use in the handling of foods, in particular when inserting portions into recesses of packages, are generally known to the skilled person so that further statements are not necessary here.

The bottom film 23 provided with the filled recesses 29 and the top film 25 are subsequently fed to the sealing station 15 that comprises a top tool 15a and a bottom tool 15b. The top film 25 and the bottom film 23 are connected to one another by means of these tools 15a, 15b. The recesses 29 and thus the packages 21 formed by the top film 25 and the bottom film 23 are hereby closed. Sealing points 43, also designated as sealing seams 43, that extend transversely to the conveying direction F are schematically indicated in FIG. 1.

Subsequent to the sealing station 15, the packages 21 are still connected by the top film 25 and the bottom film 23 and therefore still have to be separated. The transverse separation station 17 and the longitudinal separation station 19 serve this purpose.

In the embodiment example shown here, the packages 21 are provided with labels 54 and/or printed at the labeling and/or printing station 16 before the separation. The labeling and the printing can also take place in separate stations.

Further conveyor belts and/or work stations, for example a scale 58 for checking the weight of the packages 21, can be provided downstream of the separation stations 17, 19. The scale 58 forms a sensor 56 for detecting irregularities, which will now be discussed in more detail.

The operation of the entire food processing line 1 can be monitored based on data or measurement results of measurement devices, i.e. of sensors 56, and adjusted as required. For this purpose, the measurement results are evaluated by a sensor apparatus 52 to determine irregularities in the measurement results and thus in the operating procedure. Furthermore, images, in particular videos, of the various stations 2, 3, 11, 13, 15, 17, 19 of the food processing line 1 are continuously recorded during operation. The cameras 54 are arranged and aligned such that images of regions of the stations 2, 3, 11, 13, 15, 17, 19 are recorded, which can be helpful for determining causes of possible irregularities. The cameras 54 and the sensors 56 are each connected via data transmission means 38 to the data processing device 60.

Examples of how the sensor apparatus 52 and the data processing device 60 are used to automatically determine irregularities and automatically initiate countermeasures are now described below.

For example, a camera 54 in the region of the insertion station 13 can detect that the product slices are not—as predetermined—disposed concentrically above one another and can determine this as an irregularity if a position of one slice deviates from the position of another slice by more than a defined limit value. The camera 54 then sends a message to the data processing device 60 with the information “type of irregularity” and “point in time of the detected irregularity”. The data processing device 60 then automatically analyzes those images of the cameras 54 that could have included images relevant for determining a cause of the transmitted irregularity. For example, the images of the camera 54 that films the portioning belt 30 of the slicing machine 3 are analyzed to determine whether the product slices have already been placed non-concentrically on the portioning belt 30. In this respect, the images generated by the camera 54 at the slicing machine 3 are compared with data sets that include stacks of slices disposed concentrically above one another and stacks of slices disposed non-concentrically above one another. The data processing device 60 decides by means of artificial intelligence whether the stacks formed by the slicing machine 3 are arranged sufficiently concentrically or not. If the stacks formed by the slicing machine 3 are concentric as required, the images of the camera 54 that films the insertion station 13 are analyzed. For example, one cause of the individual slices of a portion 10 not being disposed concentrically above one another may be that the upper slices slip relative to the lower slices of the portion on an insertion into the packages 21 due to the sloping surface of the endless conveyor belt 13a. By means of the images recorded by the camera 54 in the region of the insertion station 13 and a comparison with data sets that show images of slipped slices of a portion, it can be determined whether the slices slip during a transport via the endless conveyor belt 13a.

The data processing device 60 then determines anomalies, i.e. relevant differences between the measured data and data sets relating to past irregularities, for example by comparing data measured by means of sensors 56 at the point in time of the occurrence of the irregularity with stored data sets. For example, the environmental temperature can be increased in the region of the endless conveyor belt 13b so that the upper slices of the portion 10 are warmer than usual and can therefore slip more easily on the lower slices of the portion. The data processing device 60 can thus determine the cause of the irregularity. If the cause is a cause that can be eliminated automatically, the data processing device 60 can automatically initiate countermeasures. In the present case, the angle of the endless conveyor belt 13a could, for example, be changed by a servomotor to prevent an unwanted slipping of the slices. Alternatively or additionally, the environmental temperature could be lowered by adjusting an air conditioning system installed in the production hall so that it cools the environmental air of the endless conveyor belt 13b more.

It can then be checked whether the countermeasure has achieved the desired result. For this purpose, the images of the camera 54 of the insertion station 13 can be analyzed again.

The skilled person will understand that there are countless examples for determining irregularities and their causes.

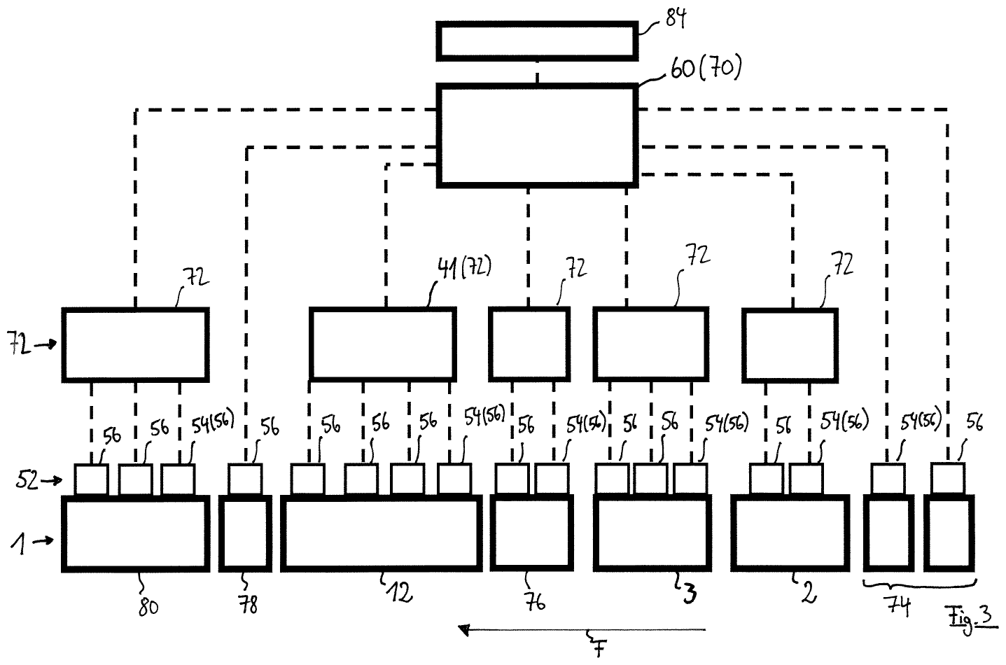

A schematic diagram of a multi-stage line control 70, which can be used to control the food processing line 1 of FIGS. 1 and 2, is shown in FIG. 3. The line control 70 comprises a sensor apparatus having a plurality of sensors 56, wherein some sensors are configured as a camera 54 and others are configured as different sensors 56, which are preferably necessary for operation, of line components. The line control 70 links control modules 72 of different stations. In the present example, the food processing line 1 initially comprises a plurality of stations 74 for product preparation, viewed in the conveying direction F. These stations 74 can comprise a storage station, a maturing station, a pre-treatment station, a drying station, a humidifying station and/or a temperature control station. The scanner 2 adjoins the stations 74. The slicing machine 3 is provided downstream of the scanner 2 in the food processing line 1. A sorting and conveying path 76, adjoined by the packaging machine 12, is provided downstream of the slicing machine 3. A final inspection station 78, adjoined by a final packaging station 80, is located downstream of the packaging machine 12.

Each of these stations 74, 2, 3, 76, 12, 78, 80 of the food processing line 1 has at least one sensor 56 that records process data. Irregularities in the process data can be determined based on the process data acquired by sensors and on a comparison with desired ranges of the process data. A first group of stations, which in the present case includes the scanner 2, the slicing machine 3, the sorting and conveying path 76, the packaging machine 12 and the final packaging station 80, has a respective station-internal control device 41, 72. If sensors 56 of these stations 72 recognize an irregularity in the process data, they first send this information to the respective station-internal control device 72. It automatically checks based on camera images of the station whether there is a station-internal cause for the irregularity. If this is the case, a station-internal countermeasure is sought after. However, if no station-internal cause can be determined, the irregularity is forwarded to the cross-station line control 70. This line control 70 analyzes all the process data of all the sensors of all the stations to determine the cause of the irregularity. The line control 70 is connected to a production control. Thus, software for monitoring entire production halls/locations or also, simply, only the production management/the management can be meant.

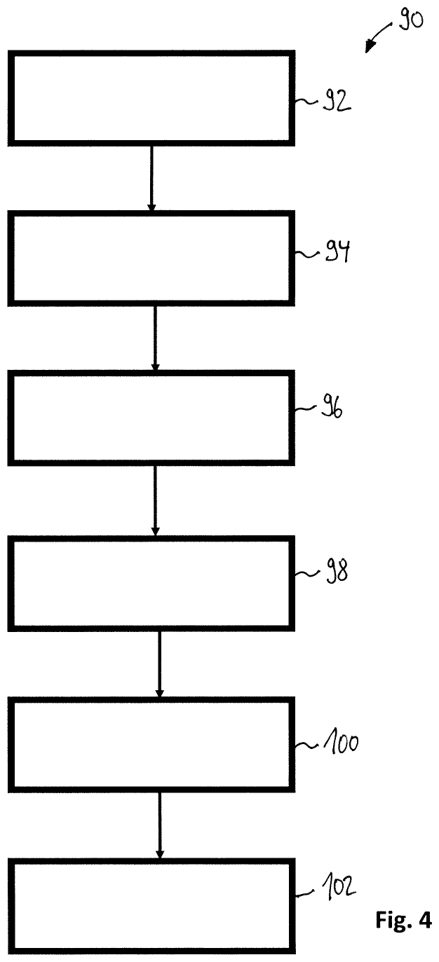

FIG. 4 shows a flowchart of a method 90 according to the invention.

The method 90 serves to operate a food processing line 1, for example as it was previously described. The method 90 first comprises detecting 92 at least one section of the food processing line 1 by means of a camera 54. The camera 54 in this respect films a region of the food processing line 1 continuously, or at least when there are products in this region, while the food processing line 1 is in operation. If an irregularity occurs in the operating procedure, a detection 94 of the irregularity in the operating procedure is performed by means of at least one sensor 56 in a further step. In other words, an irregularity in the operating procedure is detected by means of at least one sensor 56. The sensor 56 can be a sensor that supplies data relevant for controlling the food processing line 1. The sensor can be configured as a camera 56. To be able to find the cause of the irregularity more quickly, a point in time of the detection of the irregularity is also determined in a further step 96. This is followed, in a further step, by an automatic selection 98 of the data acquired by the camera 54 in the period in which the irregularity arose. Subsequently, the cause of the irregularity is determined by means of the selected data in a further step 100. The determination 100 of the cause of the irregularity can be automatically performed by a data processing device 60 by means of the selected data. For this purpose, an evaluation of measured data of a plurality of sensors 54 along the food processing line 1 can take place. For example, data sets, in particular images, determined in the period of the detected irregularity can be compared with data sets, in particular images, created in the past that relate to irregularities detected in the past. So that the determination 100 of the cause of the irregularity can be performed as precisely as possible in an automated manner, it is advantageous to perform the determination 100 of the cause of the irregularity by using artificial intelligence. For example, by analyzing videos by means of artificial intelligence, it can be determined what the cause of the irregularity is or was.

Finally, in a step 102, the at least one cause of the irregularity is eliminated by means of measures necessary for this purpose. The elimination 102 of the cause of the irregularity by means of measures necessary for this purpose can be automatically performed by the data processing device 60. For this purpose, a change to a setting of the food processing line 1 can be automatically performed. For example, a servomotor can be controlled that adjusts an operating parameter, such as the cutting gap width, to a changed desired value. Alternatively thereto, the cause of the irregularity can be eliminated by a user, in particular if the elimination cannot be performed automatically.

Once the cause of the irregularity has been successfully eliminated, the measures required to eliminate the cause can be saved, in particular automatically. Thus, the food processing line 1 can automatically learn how various irregularities can be eliminated. If similar or identical irregularities are then detected in the operating procedure, the irregularities can be easily eliminated by means of the saved measures.

### REFERENCE NUMERAL LIST

1 food processing line
2 scanner
3 slicing machine
4 food product
5 product feed
5a product holder
5b spindle nut
5c spindle
6 cutting plane
7 cutting blade
8 product passage
9 counter-blade
10 portion
11 molding station
11a top tool
11b bottom tool
12 packaging machine
13 insertion station
13a endless conveyor belt
13b endless conveyor belt
14 feed station
15 sealing station
15a top tool
15b bottom tool
16 labeling station
17 transverse separation station
19 longitudinal separation station
21 package
23 bottom film
23a supply roll
25 top film
25a supply roll
27 transport chain
29 recess
30 portioning belt
36 conveyor belt
38 data transmission means
41 control device
43 sealing point
45 operating device
47 machine frame
50 robot
52 sensor apparatus
54 camera
56 sensor
58 scale
60 data processing device
71 line control
72 station-internal control device
74 product preparation station
76 sorting and conveying path
78 final inspection station
80 final packaging station
82 station-internal control device
84 production control
90 method
92 detection of a section
94 detection of an irregularity
96 determination of a point in time
98 automatic selection
100 determination of the cause
102 elimination of the cause
F conveying direction
Z feed direction

1. A food processing line comprising,
a sensor apparatus for determining at least one irregularity in the food processing line and a point in time of the at least one irregularity;
at least one camera configured to continuously record a plurality of images of at least one region of the food processing line; and
a central data processing device that, during operation of the food processing line, receives sensor data from the sensor apparatus and receives the plurality of images from the at least one camera and is configured to select at least a subset of the plurality of images that are relevant for determining a cause of the at least one irregularity from the plurality of images recorded by the at least one camera.

2. The food processing line of claim 1,
wherein the central data processing device is configured to automatically recognize the cause and/or a point of origin of the at least one irregularity based on the subset of the plurality of images and/or at least a subset of the sensor data of the sensor apparatus and to initiate suitable countermeasures.

3. The food processing line of claim 1,
wherein the central data processing device is configured to learn through machine learning the cause of the at least one irregularity and/or how the at least one irregularity is to be eliminated.

4. The food processing line of claim 1,
wherein the at least one camera comprises a plurality of cameras, and
wherein each of the plurality of cameras, during operation, continuously records images of a different region of the food processing line.

5. The food processing line of claim 1,
wherein the sensor apparatus comprises a plurality of sensors to determine various irregularities in the food processing line.

6. The food processing line of claim 1,
wherein the sensor apparatus comprises the at least one camera.

7. The food processing line of claim 1,
wherein the at least one irregularity comprises at least two irregularities, and
wherein the central data processing device is configured to automatically perform a prioritization of an irregularity of the at least two irregularities when the at least two irregularities simultaneously occur.

8. The food processing line of claim 1,
wherein the central data processing device is configured to detect trends based on the at least one irregularity.

9. The food processing line of claim 1,
wherein the central data processing device is configured to determine incorrect settings at the food processing line based on the at least one irregularity.

10. The food processing line according to claim 1,
wherein the at least one camera is a spectral camera.

11. A method of operating a food processing line, comprising:
imaging at least one section of the food processing line using a camera,
detecting an irregularity in the food processing line using at least one sensor,
determining a point in time of the detection of the irregularity,
automatically selecting at least one image acquired by the camera in time period in which the irregularity arose, and
determining a cause of the irregularity based on the at least one image.

12. The method of claim 11, further comprising:
determining a type of the cause of the irregularity; and
eliminating the cause of the irregularity based on the type.

13. The method of claim 11,
wherein determining the cause of the irregularity is automatically performed by a data processing device based on the at least one image.

14. The method of claim 11,
wherein determining the cause of the irregularity comprises evaluating measured data from a plurality of sensors along the food processing line.

15. The method of claim 12,
wherein the elimination of the cause of the irregularity is performed based on historical data sets of past irregularities.

16. The method of claim 12,
wherein the elimination of the cause of the irregularity comprises changing a setting of the food processing line.

17. The method of claim 12, further comprising:
saving at least one measure required for eliminating the cause;
detecting similar or identical irregularities in the food processing line using the at least one sensor; and
automatically eliminating the cause of the similar or identical irregularities using the at least one measure.

18. The method of claim 11,
wherein determining the cause of the irregularity comprises comparing data collected on the irregularity with data from previously detected irregularities.

19. The method of claim 11,
wherein determining the cause of the irregularity is performed using artificial intelligence.

20. The method of claim 11,
wherein a determination of a dependency between the cause of the irregularity and the irregularity is performed using artificial intelligence.

21. The method of claim 11, further comprising:
categorizing the irregularity by at least one of: a type of irregularity, a component associated with the irregularity, the point in time of detecting the irregularity, the point in time of an occurrence of the irregularity, a severity of the irregularity.

22. The method of claim 11, further comprising:
differentiating whether the irregularity is an isolated case or a recurring irregularity.

23. The method of claim 15,
wherein the elimination of the cause of the irregularity is automatically performed by a data processing device.

24. The method of claim 11,
wherein the at least one image acquired by the camera is processed before the at least one image is released for output.

25. The food processing line of claim 1, further comprising:
at least one of: a slicing machine, a sorting and conveying path, or a packaging machine.

26. The food processing line of claim 4, wherein the plurality of cameras comprises mobile cameras and stationary cameras.

27. The food processing line of claim 5, wherein the plurality of sensors comprises different sensor types.

28. The food processing line of claim 8, wherein the trends comprise wear at the food processing line.

29. The food processing line of claim 9, wherein the central data processing device is configured to automatically correct the incorrect settings.
